(19) United States
(12) Patent Application Publication
(10) Pub. No.: US 2013/0118361 A1
(43) Pub. Date: May 16, 2013

(54) THERMAL EQUIPMENT THAT CAN BE MODIFIED TO EXTEND AND CONTROL THE THERMAL INERTIA OF INSULATED CONTAINERS

(71) Applicant: Edwige Truyts, Lausanne (CH)

(72) Inventor: Edwige Truyts, Lausanne (CH)

(21) Appl. No.: 13/642,287

(22) PCT Filed: May 23, 2011
(86) PCT No.: PCT/IB2011/052242

§ 371 Date: Dec. 4, 2012

(30) Foreign Application Priority Data
May 28, 2010 (BE) BE 2010/0325

(51) Int. Cl. A47J 36/24; H05B 1/02

(52) U.S. Cl. CPC A47J 36/2483; H05B 1/0261
USPC 99/483; 220/592.22; 219/494

(57) ABSTRACT

The modifiable thermal equipment (9) is made up of an insulating container (I) and of a high-emissivity heating body (2) sharing a common conduction surface (3). The thermal equipment (9) closed by an insulator (4) and by the lid (5) and through which there passes a thermal flux (7) defined by a temperature limiter (6), is capable of storing and of releasing the thermal flux (8) directed towards the container and of controlling the rate of cooling thereof by modifying the ambient conditions of the said container in order to cook or to keep at a precise temperature, through the inertia of transmission, the foodstuffs contained in the container (1).

The present invention relates to an adjustable and mobile thermal apparatus enabling prolongment and control of the thermal inertia of insulated containers designed for the distribution of hot meals or cooking.

Catering services distribute hot meals in the form of buffets or self-service counters (common) or plates/dishes from insulated trolleys (hospital, canteen, nursing homes). These concepts of catering can be improved, in the area of: environmental, sociological, and food quality. The service plate from the kitchen partially answers the global quality criteria defined by consumers, but its cost and constraints are only suitable for a limited number of place setting as for example in (haut) cuisine. When a large number of people must be served, catering concepts are subject to criticism: lines, noise, discomfort, meals eaten cold, eaten fast, bad cooking, repetitive menus, fat, lack of variety, . . . However, the work tool has basically not fundamentally changed while the constraints are increasing with the growing number of meals eaten outside the home.

Whatever the version, the water bath is the means available for maintaining foods warm that are stationed in the kitchen waiting to be then served on a plate. It is also the basis of operation of self-service counter or, set on a buffet connected to a heating radiator, with a burner for autonomy. Constraints related to the handling, the stainless steel of which causing low energy efficiency and temperature lability, makes it not very suitable for hot meal service. To avoid any risk of contamination (development of pathogens in warm medium), the standards (HACCP) recommend keeping hot foods cooked above 63° during the entire production and service/distribution period in order to avoid breaking the chain of heat. This is why, failing achieve this condition, they advocate chilling.

The dishes are then industrially prepared in a central kitchen and arranged in stainless steel tanks be heated/regenerated then in satellite kitchens and then arranged in the self-service water baths from where they are transported by the consumer himself. The process is long and involves many operations of packaging, storage in a cold room, refrigerated transport, numerous apparatus and premises, at which additional apparatus must be added: infrared lamps, hot plates, microwave distributed over the distance to travelled for staging with the cooling of food. Energy costs and those inherent in handling accumulate and are imputed on the overall cost of the meal at the expense of added value in “quality food” locally produced, seasonal, or with the expertise of the cook. Having an impact on the methods of production/distribution, the work tool has implications for the quality of services but also on the environment and resources.

To meet expectations, equipment designed to maintain food temperature must be multifunctional and flexible. By exploiting the thermal characteristics of insulating material containers usually used for cooking or food presentation: ceramic, porcelain, stoneware, terracotta, earthenware or cast iron radiators assembled with heating bodies constituted by materials with high radiation/thermal conductivity and as an example: cast aluminum, copper or other alloy molten metal, etc. the improvement of Patent EP No. 0 9 14 792 B1 constitutes multifunctional, adjustable thermal side tables that combine mobility, aesthetics and small footprint for self serve or on a plate near the tables, on a familial and friendly model, while other modes of heating, by induction, ceramic hob, insulated trolleys, thermos are fixed and/or closed systems being both more cumbersome and inflexible.

In addition, the mode of heating by thermal inertia offers many advantages such as: a gentle homogeneous heat, absorbing variations in temperature, not changing the level of humidity in containers more suitable and conducive to control of the temperature of food to preserve organoleptic, visual quality, and secure the heat chain. A mode of operation that provides a catering tool meeting the technical standards in order to facilitate more efficient logistics, allowing the heat chain, shorter processes, less expensive apparatus and less energy combined with the energy efficiency of the thermal inertia, as many factors have repercussions upstream on the choice of products and the use of resources: seasonal and local production, impact on crops, and intensive farming.

The adjustable thermal apparatus can be manufactured with great flexibility in space, ergonomics, interior architecture, thus meeting sociological standards of quality catering whether commercial, common, or in transportation.

### NOTES TO THE EXAMINER

1. The improvement of the layout of EP Patent No. 0 9 14 792 B1 makes applicable a thermodynamic theory of heat flow in materials having opposite thermal properties enabling the prolongment and control of thermal inertia. This represents an advantage especially in professional catering. Each apparatus is adapted to store and release heat and to control its cooling rate resulting from a mathematical relation due to thermal exchanges taking into account the coefficients of conductivity of the materials brought together, their respective mass and the conduction surface, in each apparatus according to the claim, in order to make thermal side tables of different sizes

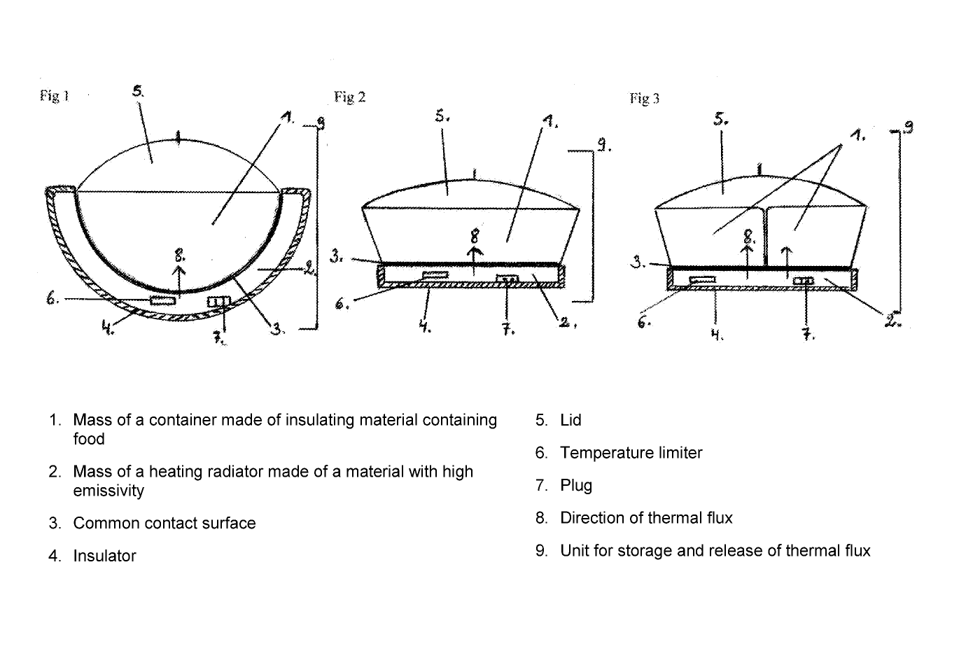

2. There is no (FIG. 1) or little (FIG. 2, 3) heat loss other than that which escapes through the container for the benefit of the food.

3. The residual heat in the system enables a fast reinitialization of the temperature by brief reconnections during the inertial phase.

1-4. (canceled)

5. An adjustable thermal apparatus configured to prolong the temperature of hot foods in order to offer them near tables and constituted by a container configured to contain hot foods and equipped with a lid, the container constituted by a mass of a heat insulating material whose wall forming the bottom that bounds a contact surface, and a heating radiator constituted by a mass of material characterized by an elevated thermal conductivity, the heating radiator having an electric current power supply plug and a contact surface configured to provide heat conduction between the contact surface of the container and the contact surface of the heating radiator, the remaining surface of the heating radiator being covered with an insulator, the container is not connected to the electrical power supply, the mass of the container and the mass of the heating radiator and their common contact surfaces form a double-walled thermal apparatus that, connected to the electrical power supply, directs the thermal flux defined by a temperature limiter, towards the mass of the container, the container, exerting a buffering effect on the radiation from the mass of the heating radiator, increasing the heat storage and release capacity of the thermal flux into the apparatus, modifying the ambient conditions of the container, the masses of the material forming the double wall of the thermal apparatus thus define its cooling rate enabling prolongment and control, as energy saving, of the temperature transmitted to the food, as long as the logistics of distribution of the meals, the thermal apparatus formed thus defining its cooling rate enabling prolongment and control, as energy saving, of the temperature transmitted to the food, as long as the logistics of distribution of the meals requires it.

6. An adjustable thermal apparatus according to claim 5, with an electronic system connected to a thermostat operates, depending on phase shifts, a program of short connections between the phases of disconnection to the electric power supply in order to manage the temperature when the thermal inertia must be prolonged as needed; maintaining above 63° for the heat chain or a slow cooking.

7. An adjustable thermal apparatus according to claim 5, with multiple containers partially bounding the contact surface of a common heating radiator.

8. An adjustable thermal apparatus according to claim 5, characterized in that the thermally insulating material is ceramic, particularly porcelain.

9. An adjustable thermal apparatus according to claim 5, characterized in-that the material of the heating radiator characterized by a high thermal conductivity is of cast aluminum, copper, or an alloy of molten metals.

10. An adjustable thermal apparatus according to claim 5, characterized in that the mass of the heater element with a common surface of contact with the totality of the bottom of the container, and particularly in that the mass is enclosed between the bottom of the container and a layer of the insulator.

11. A multi-selection thermal side table, constituted by multiple thermal apparatus as recited in claim 5.
